(19) United States
(12) Patent Application Publication
(10) Pub. No.: US 2005/0213022 A1
(43) Pub. Date: Sep. 29, 2005

(54) Method and apparatus for correcting a defective pixel of a liquid crystal display

(76) Inventor: Yoshitaka Kawada, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/086,230

(22) Filed: Mar. 23, 2005

(30) Foreign Application Priority Data
Mar. 25, 2004 (JP) 2004-090117

(51) Int. Cl. G02F 1/13; G02F 1/1343

(52) U.S. Cl. 349/192; 349/55

(57) ABSTRACT

A method of correcting a defective pixel of a liquid crystal display by scanning the defective pixel with a laser beam. The liquid crystal display is moved to let the defective pixel face a lens which converges the laser beam. The laser beam is relatively moved to the lens in a direction orthogonal to the optical axis of the laser beam to scan the defective pixel.

### CROSS REFERENCE TO RELATED APPLICATION

This application is based upon and claims the benefit of priority from the prior Japanese Patent Application No. 2004-90117 filed on Mar. 25, 2004; the entire contents of which are incorporated herein by reference.

### BACKGROUND

1. Technical Field

The present invention relates to a method and apparatus for correcting a defective pixel of a liquid crystal display, in particular to a method and apparatus for correcting a defective pixel of a liquid crystal display by scanning the defective pixel using a laser beam.

2. Description of the Related Art

When manufacturing a liquid crystal display (LCD), a defective pixels may be formed where a thin film transistor (TFT) does not operate correctly or the liquid crystal is not correctly oriented. Such a defective pixel results in a bright point defect since the defective pixel cannot block transmitted light. Even though various measures may be taken during the design and manufacturing processes to reduce a rate of occurrence of the bright point defects, which can decrease the display quality, it is quite difficult to lower the rate of occurrence of the bright point defects.

In current methods, each pixel of a LCD is checked whether or not there is a defective pixel after the LCD is fabricated. When there is a defective pixel, it is corrected one by one. Japanese Patent Disclosure No. 07-225381, No. 08-015660, No. 08-201813 and No. 10-260419 show methods of correcting a defective pixel by irradiating a laser beam on such a defective pixel to decrease a transmissivity thereof.

The methods of correcting a defective pixel shown in these disclosures use a laser apparatus which emits a laser beam to irradiate the defective pixel through a focus lens. Before the irradiation, a stage holding an LDC is moved such that the defective pixel is positioned just below the focus lens. This movement is a positioning movement. Then, the defective pixel is irradiated with a laser beam converged by the focus lens. The laser beam operates on an alignment film formed on a glass substrate to generate minute particles. The minute particles fly in all directions from the working point and deposit on an inner surface of the defective pixel. The deposition of the minute particles decreases an orientation of the alignment film to liquid crystal molecules so that the liquid crystal molecules in the defective pixel are arranged in random orientation. As a result, a transmissivity of the defective pixel decreases and the defective pixel becomes indistinctive.

When working the alignment film using the conventional method described above, a laser beam scans the defective pixel to work the entire part of the alignment film of the defective film. This movement is called a scanning movement. The scanning movement is carried out by moving a stage holding an LCD, to relatively move a laser beam with respect to the LCD. Since a laser beam does not move relative to the focus lens, it is possible for the optical axis of the laser beam to always pass through the center of the focus lens. Thus, a scanning path can be stabilized.

However in correcting a defective pixel of a large-sized LCD such as a display for a television, a positioning resolution of the positioning movement differs substantially from that of the scanning movement. Therefore, it is difficult for the table to be compatible with both the scanning and positioning movements.

Some apparatuses have a first stage for the positioning movement and a second stage for the scanning movement. Specifically, the scanning movement is accomplished by moving a table of the second stage to which a laser apparatus, an attenuator, a monitor and an optical system are secured.

Meanwhile, a kind of a defect of a defective pixel is not found until it is checked by a correcting apparatus. Therefore, it will be more effective if a single correcting apparatus can correct several kinds of defective pixels.

In order for a correcting apparatus to correct several kinds of defective pixels, the correcting apparatus has both a collective optical system and an imaging optical system. However, an imaging optical system is so heavy that moving the optical system with fine positioning resolution for the scanning movement is quite difficult if both the imaging and collective optical systems are secured to the same table.

### SUMMARY

Consistent with the present invention, there is a method of correcting a defective pixel of a liquid crystal display by scanning the defective pixel with a laser beam. The method comprises moving the liquid crystal display to let the defective pixel face a lens which converges the laser beam, and moving the laser beam relative to the lens in a direction orthogonal to the optical axis of the laser beam to scan the defective pixel.

In another aspect consistent with the present invention, there is an apparatus for correcting a defective pixel of a liquid crystal display. The apparatus comprises a laser apparatus to emit a laser beam, a lens to converge the laser beam, a first stage to move the liquid crystal display for letting the defective pixel face the lens, and a second stage to move the lens in a direction orthogonal to the optical axis of the laser beam for scanning the defective pixel by the laser beam.

In another aspect consistent with the present invention, there is an apparatus for correcting a defective pixel of a liquid crystal display. The apparatus comprises a laser apparatus to emit a laser beam, a lens to converge the laser beam, a first stage to move the liquid crystal display for letting the defective pixel face the lens, and a scanner to move the laser beam in a direction orthogonal to the optical axis of the laser beam for scanning the defective pixel by the laser beam.

### BRIEF DESCRIPTION OF THE DRAWING

FIG. 1 is a schematic diagram of an apparatus 100 for correcting a defective pixel of a liquid crystal display D.

FIG. 2 is a schematic diagram of a laser apparatus 7.

FIG. 3 shows intensity distributions of a laser beam L under certain LD temperatures with a repetition frequency of laser beam L 1 kHz, and a LD current 20.0 A.

FIG. 4 is a scanning path of laser beam L which forms laser spots S.

FIG. 5 is a relationship between a repetition frequency (f), a diameter (d) of laser spot S and a scanning speed (V).

FIG. 6 shows a schematic sectional diagram of liquid crystal display D.

FIG. 7 is a schematic diagram of an apparatus 200 for correcting a defective pixel of a liquid crystal display D.

FIG. 8 shows an intensity distribution of laser beam L, and a positional relationship between a transparent hole 4 and laser beam L which form laser spot S.

FIG. 9 shows a relationship between an intensity of laser beam L, and a relative position between laser beam L and transparent hole 4.

FIG. 10 shows a schematic diagram of an apparatus 300 for correcting a defective pixel of a liquid crystal display D.

FIG. 11 shows a scanning path of laser beam L of a fifth embodiment in consistent with the present invention.

FIG. 12 shows a scanning path of laser beam L of a sixth embodiment in consistent with the present invention.

### DETAILED DESCRIPTION

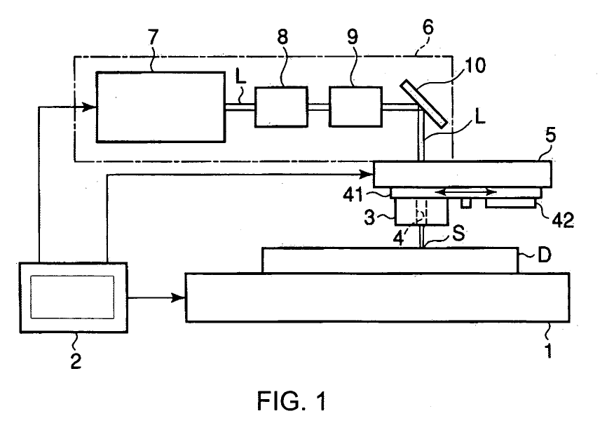

A first embodiment consistent with the present invention is explained with reference to FIGS. 1 to 6.

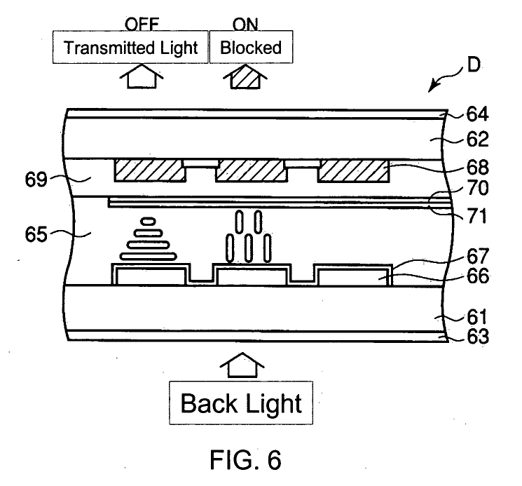

First, a structure of a liquid crystal display (LCD) D is explained with reference to FIG. 6. FIG. 6 is a vertical cross section of LCD D.

LCD D is provided with a pair of glass substrates 61 and 62 facing each other. Polarizing films 63 and 64 are respectively bonded on the outer surfaces of glass substrates 61 and 62. Liquid crystal 65 is sealed between glass substrates 61 and 62.

Thin film transistors (TFTs) 66, formed on the inner surface of glass substrate 61, are arranged in a grid. An alignment film 67 is formed on TFTs 66. A color filter 68, which is red, green or blue, is formed on the inner surface of glass substrate 62, facing TFT 66. A cover film 69 is formed on color filer 68. An indium tin oxide (ITO) film 70 and an alignment film 71 are further formed in this order.

Driving TFT 66 of LCD D changes an orientation of liquid crystal molecules 66 to control a transmission and cut off of back light.

An apparatus 100 for correcting a defective pixel of an LCD is explained next with reference to FIGS. 1 to 5.

FIG. 1 shows a schematic diagram of apparatus 100.

As shown in FIG. 1, apparatus 100 is provided with a first stage 1 connected to a controller 2. Controller 2 gives a command signal to first stage 1 to move a liquid crystal display (LCD) D held thereby. First stage 1 is a large stroke positioning stage to move LCD by several millimeters to several hundred millimeters.

A condenser lens 3 (lens) of high power to converge a laser beam L is arranged above a top face of first stage 1. Condenser lens 3 is column-shaped. The axis of condenser lens 3 is substantially orthogonal to the top face of first stage 1. A transparent hole 4 is formed in the center in a radial direction of condenser lens 3, extending along the axis of condenser lens 3. A laser beam L from above passes through transparent hole 4 and forms a laser spot S below condenser lens 3.

In this embodiment, a diameter of laser beam L is smaller than the internal diameter of transparent hole 4 of condenser lens 3 so that laser beam L is completely made incident to transparent hole 4.

An electric revolver 41 holds not only condenser lens 3 but also an objective lens 42 of low power to observe a defective pixel G. Revolver 41 rotates to select between condenser lens 3 and objective lens 42.

A second stage 5 holds revolver 41. Second stage 5, connected to controller 2, moves condenser lens 3 with revolver 41 in the X and Y directions, which are directions orthogonal to the optical axis of laser beam L, according to a command signal from controller 2. Second stage 5 is a small stroke stage to move condenser lens 3 by several micrometers to several hundred micrometers.

Laser apparatus 6 which emits laser beam L is provided with a laser oscillator 7, an attenuator 8, a power monitor 8 and a reflection mirror 10.

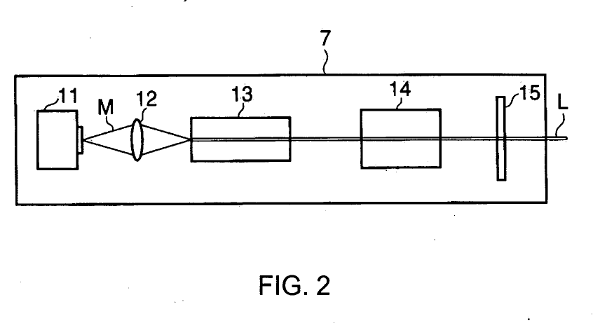

FIG. 2 shows a schematic diagram of laser oscillator 7. Laser oscillator 7 is provided with a laser diode (LD) 11, an excitation light lens 12, a laser rod 13, a Q-switch 14 and an output mirror 15. Laser rod 13 is a base metal crystal of YVO₄ doped with Nd. LD 11 is configured to be able to variably set an LD temperature thereof.

Supplying a current to LD 11 emits excitation light M from an active layer (not shown). Excitation light M is made incident into laser rod 13 through excitation light lens 12. Laser rod 13, Q-switch 14 and output mirror 15 resonate excitation light M and output it as laser beam L. A mode of laser beam L outputted from laser apparatus 7 depends on an LD temperature of LD 11 since excitation light M has a temperature dependency.

That is, a wavelength of excitation light M depends on an LD temperature of LD 11. The absorption of excitation light M to Nd doped in laser rod 13 depends on the wavelength of excitation light M. Therefore, a heating degree of laser rod 13 changes according to the LD temperature. Then, laser rod 13 is deformed according to the heating degree, and the thermal lens effect changes a mode of laser beam L.

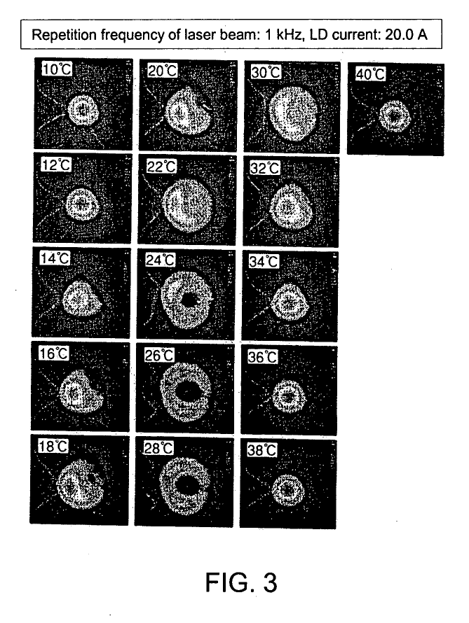

FIG. 3 shows a relationship between laser beam L and an LD temperature of LD 11 under the condition that a current supplied to LD 11 is 20.0 A and a repetition frequency of laser beam L is 1 kHz.

As shown in FIG. 3, when an LD temperature of LD 11 is 26 to 28 degrees Celsius, laser beam L has a ring-shaped intensity distribution, which is so-called multimode. When an LD temperature of LD 11 is 38 to 40 degrees Celsius, laser beam L has a Gaussian intensity distribution, which is so-called single-mode (TEMoo).

An operation of apparatus 100 is described next.

When defective pixel G is detected in LCD D, first stage 1 moves defective pixel G to let defective pixel G face condenser lens 3. When defective pixel G is positioned just below transparent hole 4, an LD temperature of LD 11 is adjusted at 26 to 28 degrees Celsius to emit a multi-mode laser beam for generating an air bubble.

Passing through attenuator 8 and power monitor 9, laser beam L, which is a multi-mode laser beam, is reflected off reflection mirror 10 so as to pass through transparent hole 4. Then, condenser lens 3 converges laser beam L to form laser spot S on defective pixel G.

Laser spot S gradually heats defective pixel G, causing an air bubble between glass substrates 61 and 62. Since laser beam L is multi-mode, which has a low energy density, alignment films 67 and 71 experience little damage.

After the air bubble is generated between glass substrates 61 and 62, an LD temperature of LD 11 is adjusted at 38 to 40 degrees Celsius, so that laser oscillator 7 emits single-mode pulse laser beam L with repetition frequency of (f). Passing through attenuator 8 and power monitor 9, laser beam L is reflected off reflection mirror 10 so as to pass through hole 4 of condenser lens 3. Condenser lens 3 converges laser beam L to form laser spot S on defective pixel G.

Laser spot S partly melts and vaporizes, i.e., works, alignment films 67 and 71 on glass substrates 61 and 62. Minute particles fly in all directions from the working point and deposit on a surface of alignment films 67 and 71 to lower an orientation degree to liquid crystal 65. Thereby liquid crystal molecules around defective pixel G are randomly oriented. Then, a transparent light beam which causes a bright point defect decreases and defective pixel G becomes indistinctive.

While laser beam L irradiates defective pixel G, second stage 5 moves condenser lens 3 in the X and Y directions, which are directions orthogonal to an optical axis of laser beam L, to scan defective pixel G. Thus, laser spot S formed on defect pixel G moves the same distance and direction as that of condenser lens 3.

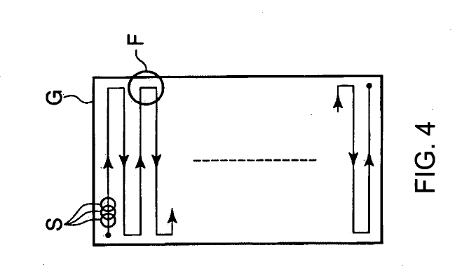

As shown in FIG. 4, laser spot S moves over defective pixel G by moving condenser lens 3 to work almost the entire alignment films 67 and 71 of defective pixel G.

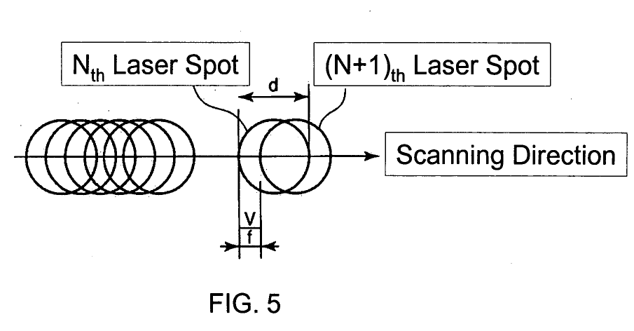

As shown in FIG. 5, each laser spot S overlaps the adjacent laser spot at a constant overlap ratio (a) by synchronizing a repetition frequency (f) of laser beam L with a movement of second stage 5. The overlap ratio (a) is expressed in a formula below when setting the converged beam diameter or laser beam L at a working point to be (d), the repetition frequency of laser beam L to be (f) and a scanning speed of laser beam L to be (v).

$$a = 1 - \frac{v}{f \times d}$$

Synchronizing repetition frequency (f) of laser beam L with the movement of second stage 5 precludes the alignment films from overheating at parts F (FIG. 4) of the scanning path where a scanning speed decreases. Thereby, the whole surface of alignment films 67 and 71 can be worked with uniform energy so as not to damage color filter 68.

Apparatus 100 has first and second stages 1 and 5. First stage 1 is a large stroke positioning stage having a low positioning resolution to position defective pixel G just below condenser lens 3. Second stage 5 is a small stroke stage having a high resolution to scan defective pixel G using laser beam L.

Even though an LCD to be corrected is a large-sized one such as an LCD for a television, apparatus 100 corrects a defective pixel by moving condenser lens 3 instead of moving laser oscillator 6. Thus, even large imaging optics, which can correct several kinds of defective pixels, can be installed.

Further, the LD temperature is controlled and changed to select between a multi-mode and single-mode of laser beams L. Thus, laser apparatus 6 can both generate an air bubble and work an alignment film by controlling only the LD temperature of LD 11, which simplifies the structure of apparatus 100.

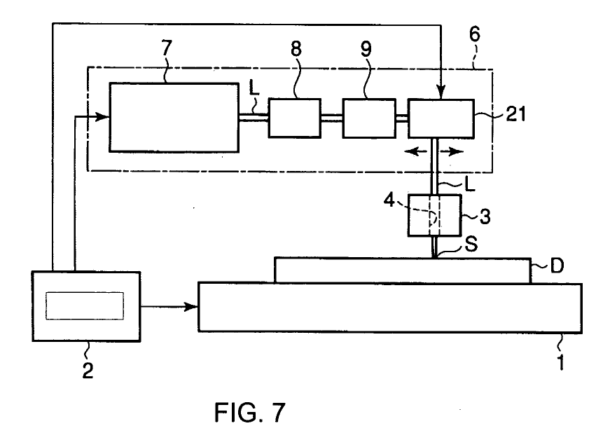

A second embodiment consistent with the present invention is explained next with reference to FIG. 7.

FIG. 7 is a schematic diagram of a correcting apparatus 200 for correcting a defective pixel of a liquid crystal display.

As shown in FIG. 7, correcting apparatus 200 is provided with a scanning unit 21 arranged between laser apparatus 6 and condenser lens 3 to scan defective pixel G by moving laser beam L emitted from laser oscillator 7 in a direction orthogonal to the optical axis of laser beam L.

Scanning unit 21 is provided with two mirrors (not shown) to reflect laser beam L. Changing angles of the two mirrors moves laser beam L in the X-direction and the Y-direction, which directions are orthogonal to the optical axis of laser beam L, before laser beam L is made incident to condenser lens 3, which is fixed in this embodiment.

Condenser lens 3 converges laser beam L to form laser spot S just below condenser lens 3. Laser spot S (laser beam L) scans defective pixel G to work alignment films 67 and 71 according to the movement of laser beam L which is moved by scanning unit 21.

Thus, defective pixel G of a large-sized liquid crystal display can be corrected. Since correcting apparatus 200 scans defective pixel G by scanning unit 21, which is not so heavy, instead of moving laser oscillator 6, correcting apparatus 200 can load a large-sized oscillator 6 having both a collective optics and imaging optics, which can correct various kinds of defects.

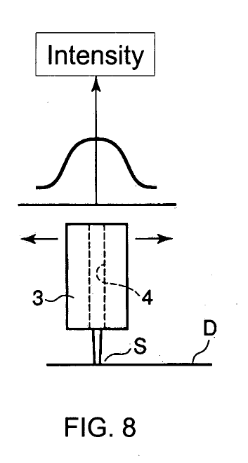

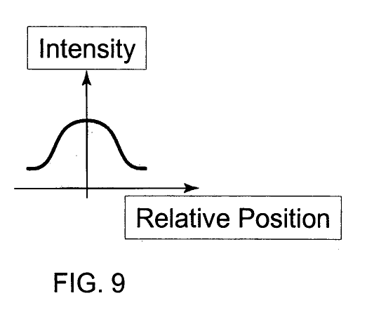

A third embodiment consistent with the present invention is explained next with reference to FIGS. 8 and 9.

FIG. 8 shows an intensity distribution of laser beam L and FIG. 9 shows an intensity distribution of laser spot S.

As shown in FIG. 8, laser beam L has a larger diameter than the inner diameter of transparent hole 4 of condenser lens 3 in this embodiment.

Laser beam L is a so-called Gaussian beam, having a nonuniform intensity distribution. Hence, as shown in FIG. 9, an intensity of laser spot S (vertical axis) depends on a relative position between laser beam L and transparent hole 4 (horizontal axis). Therefore, when defective pixel G is scanned while relatively moving laser beam to condenser lens 3, it is difficult to apply uniform energy across the whole part of defective pixel G.

Since an intensity distribution of the Gaussian beam can be theoretically known, attenuator 8 can adjust an intensity of laser beam L to apply a uniform energy across defective pixel G according to the theoretical value of laser beam L.

Even if a laser beam has an intensity distribution other than a Gaussian intensity distribution, a relationship between an intensity of laser spot S and a relative position of laser beam L to condenser lens 3 can be actually measured to adjust an intensity of laser spot S using attenuator 8 or other means.

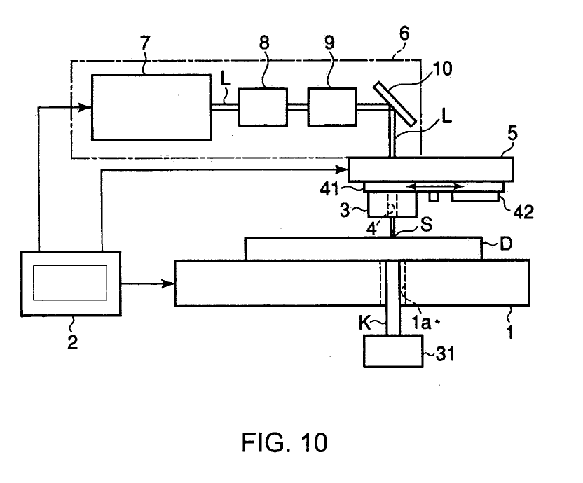

FIG. 10 shows a schematic diagram of correcting apparatus 400 for correcting a defective pixel of a liquid crystal display.

Correcting apparatus 400 is comprised of a laser diode (LD) 31 arranged below second stage 5. LD 31 emits a laser beam K to LCD D through a through-hole 1a of first stage 1 to gradually heat defective pixel G. An air bubble is generated between glass substrates 61 and 62 by laser beam K.

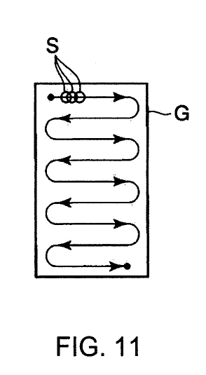

A fifth embodiment consistent with the present invention is shown next with reference to FIG. 11.

FIG. 5 shows a schematic scanning path of laser beam L.

In this embodiment, laser beam L gradually changes its direction at the replicate parts of the scanning path to keep its speed almost constant.

Thus, it is not necessary to control repetition frequency (f) of laser beam L so as to keep overlap ratio (a) constant because almost the same energy is applied to entire parts of alignment films 71 and 72 just by emitting laser beam L at a constant interval. Consequently, entire parts of alignments films 71 and 72 can be worked with almost uniform energy so as not to damage color filter 68 or ITO film 70.

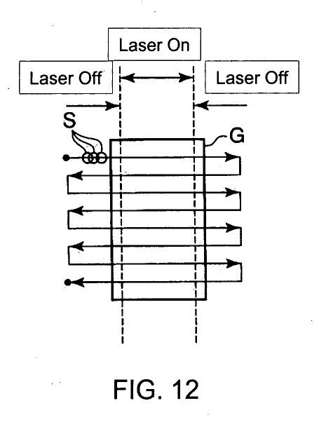

FIG. 12 shows a scanning path of defective pixel G scanned by correcting apparatus 600 of a sixth embodiment in consistent with the present invention.

As shown in FIG. 12, laser beam L moves in a first direction 602. Then, while continuing to move in first direction 602, laser beam L is kept from irradiating defective pixel G outside of defective pixel G. Laser beam L changes its direction and begins to move in a second direction 604 while being kept from irradiating defective pixel G. Laser beam L starts to irradiate defective pixel G again when laser spot S enters defective pixel G. The cutting off of laser beam L can be controlled by a mechanical or electrical shutter.

Since the replicated parts of the scanning path, where laser beam L changes its direction and the scanning speed decreases, are located outside of defective pixel G, it is not necessary to control repetition frequency (f) of laser beam L so as to keep overlap ratio (a) constant. Thus, almost the same energy is applied to entire parts of alignment films 71 and 72 just by emitting laser beam L at a constant interval. Consequently, entire parts of alignments films 71 and 72 can be worked with almost the same energy without damaging color filter 68 or ITO film 70.

Numerous modifications of the present invention are possible in light of the above teachings. It is therefore to be understood that, within the scope of the appended claims, the present invention can be practiced in a manner other than as specifically described herein.

1. A method of correcting a defective pixel of a liquid crystal display by scanning the defective pixel with a laser beam, comprising:
moving the liquid crystal display to let the defective pixel face a lens which converges the laser beam; and
moving the laser beam relative to the lens in a direction orthogonal to the optical axis of the laser beam to scan the defective pixel.

2. A method of correcting a defective pixel of a liquid crystal display according to claim 1, wherein moving the laser beam relative to the lens includes moving the lens in a direction orthogonal to the optical axis of the laser beam.

3. A method of correcting a defective pixel of a liquid crystal display according to claim 1, wherein moving the laser beam relative to the lens includes moving the laser beam in a direction orthogonal to the optical axis of the laser beam.

4. A method of correcting a defective pixel of a liquid crystal display according to claim 3, wherein moving the laser beam in a direction orthogonal to the optical axis of the laser beam includes moving the laser beam using a scanning unit having a mirror to reflect the laser beam.

5. A method of correcting a defective pixel of a liquid crystal display according to claim 1, further comprising
irradiating on the defective pixel with a laser beam to generate an air bubble before moving the laser beam relative to the lens.

6. A method of correcting a defective pixel of a liquid crystal display according to claim 5, wherein irradiating on the defective pixel with a laser beam to generate an air bubble includes irradiating on the defective pixel with a multi-mode laser beam, and moving the laser beam relative to the lens includes moving a single-mode laser beam relative to the lens.

7. A method of correcting a defective pixel of a liquid crystal display according to claim 6, further comprising
adjusting an LD temperature of a laser diode to emit a multi-mode laser beam for generating the air bubble, and
adjusting an LD temperature of the laser diode to emit a single-mode laser beam for scanning the defective pixel.

8. A method of correcting a defective pixel of a liquid crystal display according to claim 1, wherein moving the laser beam relative to the lens includes moving the laser beam relative to the lens to work an alignment film of the defective pixel.

9. A method of correcting a defective pixel of a liquid crystal display according to claim 1, further comprising adjusting an intensity of the laser beam using an attenuator.

10. A method of correcting a defective pixel of a liquid crystal display according to claim 1, wherein moving the laser beam relative to the lens includes moving a pulse laser beam relative to the lens with each laser spot on the defective pixel overlapping the adjacent laser spot at a constant overlap ratio.

11. A method of correcting a defective pixel of a liquid crystal display according to claim 1, further comprising keeping the laser beam from irradiating on the defective pixel while changing the direction of the relative movement of the laser beam to the lens.

12. A method of correcting a defective pixel of a liquid crystal display according to claim 1, wherein moving the laser beam relative to the lens includes moving the laser beam relative to the lens in a first direction orthogonal to the optical axis of the laser beam to scan the defective pixel, further comprising
keeping the laser beam from irradiating on the defective pixel while continuing to move the laser beam relative to the lens in the first direction,
changing the direction of the relative movement of the laser beam to the lens while keeping the laser beam from irradiating on the defective pixel, and
moving the laser beam relative to the lens in a second direction orthogonal to the optical axis of the laser beam to scan the defective pixel.

13. An apparatus for correcting a defective pixel of a liquid crystal display, comprising:
a laser apparatus to emit a laser beam;
a lens to converge the laser beam;
a first stage to move the liquid crystal display for letting the defective pixel face the lens; and
a second stage to move the lens in a direction orthogonal to the optical axis of the laser beam for scanning the defective pixel by the laser beam.

14. An apparatus for correcting a defective pixel of a liquid crystal display, according to claim 13, wherein the laser apparatus comprises
a laser rod; and
a laser diode to emit excitation light to the laser rod, the laser diode configured to change an LD temperature.

15. An apparatus for correcting a defective pixel of a liquid crystal display, comprising:
a laser apparatus to emit a laser beam;
a lens to converge the laser beam;
a first stage to move the liquid crystal display for letting the defective pixel face the lens; and
a scanner to move the laser beam in a direction orthogonal to the optical axis of the laser beam for scanning the defective pixel by the laser beam.

16. An apparatus for correcting a defective pixel of a liquid crystal display, according to claim 15, wherein the laser apparatus comprises
a laser rod; and
a laser diode to emit excitation light to the laser rod, the laser diode configured to change a LD temperature.
